(19) United States
(12) Patent Application Publication
(10) Pub. No.: US 2012/0286175 A1
(43) Pub. Date: Nov. 15, 2012

(54) COOLED MANIPULATOR TIP FOR REMOVAL OF FROZEN MATERIAL

(75) Inventors: Andrew Nicholas Searle, Oxon (GB); Simon Andrew Galloway, Oxford (GB); Klaus Leifer, Uppsala (SE)

(73) Assignee: GATAN, INC., Warrendale, PA (US)

(21) Appl. No.: 13/468,926

(22) Filed: May 10, 2012

Related U.S. Application Data
(60) Provisional application No. 61/485,244, filed on May 12, 2011.

(51) Int. Cl. G01N 1/08; G21K 5/00

(52) U.S. Cl. 250/492.3; 73/863.12

(57) ABSTRACT

The disclosed apparatus enables attachment to a sample to be excised from a frozen bulk sample, the transfer of the excised sample from the bulk sample to a separate cooled support structure by means of a manipulator tip that can be cooled and maintained at a temperature below that of vitreous ice and which provides both an active cooling path and cryogenic shielding to maintain the temperature of the excised sample below that of vitreous ice. The cryogenic shielding also helps minimize contamination of the cooled sample by condensation of volatile material. A method is disclosed for extracting a portion of a frozen sample, comprising attaching a thermally-isolated cooled manipulator tip to the sample with vapor deposition and removing a portion of the sample affixed to the tip without changing phase of the portion of the sample being removed, with a focused ion beam.

### CROSS-REFERENCE TO RELATED APPLICATIONS

This application is a non-provisional application of U.S. Patent Application Ser. No. 61/485,244, filed on May 12, 2011, the entire application being incorporated by reference herein.

### FIELD OF INVENTION

The invention relates to the field of apparatuses for sample manipulation in electron microscopy.

### BACKGROUND OF THE INVENTION

It is common practice when using focused ion beam (FIB) instruments to use a precision controlled sharp point (as manipulator tip) to aid the transfer of a small specimen excised from the bulk specimen using the ion beam, from the bulk specimen to another structure. The aim of this practice is to transfer the specimen from the FIB instrument into another instrument. In this way the FIB is a useful tool for creating site specific thin film specimens, e.g. for transmission electron microscopy (TEM) analysis. With material science specimens, e.g. semiconductor structures, this is achieved by localized welding of the specimen to the manipulator tip to aid “lift out” and subsequent transfer.

There is a need, however, to employ similar techniques for bulk specimens which are in the hydrated frozen vitreous states.

The ice within frozen hydrated material that is to be effectively observed using TEM must be maintained in a ‘vitreous’ form i.e. in a non-crystalline state. This vitreous ice is initially formed by rapid freezing using a separate apparatus and it must subsequently be preserved at temperatures below approximately 136 K otherwise crystallization will occur, when either cubic or hexagonal ice crystals form, in a non-reversible change of state.

Thus it is essential that all steps in a process involving the manipulation and transfer of a vitrified specimen must maintain the specimen below the temperature of vitreous ice.

Existing technology can maintain a specimen at such a temperature during the stages of the process involving transfer of the bulk sample from the rapid freezing apparatus to the FIB apparatus, holding the bulk sample within the FIB apparatus, transfer of an excised sample once mounted on a cooled support structure to a cryogenically cooled TEM specimen holder and thence to the TEM.

A patent in the field, U.S. Pat. No. 7,845,245 describes a manipulator with heating and cooling to provide a means of bonding and releasing an excised sample to and from a manipulator tip. This describes heating of the manipulator sufficient to change the phase of ice in the sample to be excised followed by cryogenic cooling of the manipulator sufficient to provide the reverse change of phase for the purposes of bonding the sample to the manipulator tip.

Because heating the sample, even briefly, could crystallize ice within part of the excised sample actively damaging it for the purposes of subsequent TEM examination, a need exists for a manipulator that does not change the phase of ice in the sample

All references cited herein are incorporated herein by reference in their entireties.

### BRIEF SUMMARY OF THE INVENTION

This disclosed apparatus enables the stage of the process involving the final excision of the sample from the bulk sample and the transfer of the excised sample from the bulk sample to the cooled support structure by means of a manipulator tip that can be cooled and maintained at a temperature below that of vitreous ice and which provides both an active cooling path and cryogenic shielding to maintain the temperature of the excised sample below that of vitreous ice. The cryogenic shielding also helps to minimize contamination of the cooled sample by condensation of volatile material.

In an embodiment, there is disclosed a method for extracting a portion of a frozen sample, comprising attaching a thermally-isolated tip of a manipulator to the sample with vapor deposition and removing a portion of the sample that is affixed to the tip without changing phase of the portion of the sample being removed, with a focused ion beam.

In an embodiment, there s disclosed a cooled manipulator tip assembly comprising a thermally isolated tip and a thermal shield, wherein the tip is adapted for bonding to a sample and for removal of a portion of the sample without changing phase of the sample portion. In a further embodiment, the thermal shield is cooled. In a further embodiment, the cooled manipulator tip assembly includes a flexible conductor adapted for cooling the thermally isolated tip.

In a further embodiment there is disclosed a system for extracting a sample portion from a cooled sample. The system includes a cooled manipulator tip assembly comprising: a thermally isolated tip and a thermal shield, and a cooled shield that is physically separate from the cooled manipulator tip assembly wherein the thermally-isolated tip is adapted for bonding to a sample and for removal of a portion of the sample without changing phase of the sample portion. In a further embodiment, the thermal shield is cooled. In a further embodiment, the system further comprises a flexible conductor adapted for cooling the thermally isolated tip. In a further embodiment, the cooled manipulator tip assembly is contained within a vacuum environment of a Focused Ion Beam system. In a further embodiment, the system further comprises a cryogenic cooling source for cooling the shield and tip.

In a further embodiment, there is disclosed a method for extracting a portion of a frozen sample. The method includes the steps of: attaching a thermally-isolated cooled tip of a manipulator to the sample, removing a portion of the sample that is affixed to the tip without changing phase of the portion of the sample being removed, transferring a portion of the sample that is affixed to the tip without changing phase of the portion to a separate cooled support structure, bonding of a portion of the sample to the separate cooled support structure and detaching the tip without changing phase of the portion of the sample. In a further embodiment, the attaching and bonding is performed by vapor deposition. In a further embodiment the removing of a portion of the sample is performed by an ion beam. In a further embodiment the sample is frozen and the thermally-isolated tip is maintained at a temperature below that of vitreous ice. In a further embodiment the deposition comprises deposition of platinum. In a further embodiment the tip is contained within a vacuum environment in a Focused Ion Beam system. In a further embodiment the method includes cooling the tip at least in part with a cryogenic cooling source. In a further embodiment the transferring is by means of in situ or ex situ movement of the manipulator tip. In a further embodiment the detaching is performed by an ion beam. In a further embodiment wherein the deposition comprises deposition of water.

### BRIEF DESCRIPTION OF SEVERAL VIEWS OF THE DRAWINGS

FIG. 1 is a three-view drawing of an embodiment of specimen manipulator according to the invention.

### DETAILED DESCRIPTION OF PREFERRED EMBODIMENTS OF THE INVENTION

The disclosed apparatus relies on an established method of bonding and releasing the manipulator tip to and from the sample, using Ion Beam Induced Deposition, for example using a Pt precursor gas injected towards a target region in more than one step for bonding and use of the FIB to ‘compact’ the Pt deposit, for cleaning any superfluous Pt deposit and for releasing the manipulator tip from the sample following sample bonding to the cooled support structure.

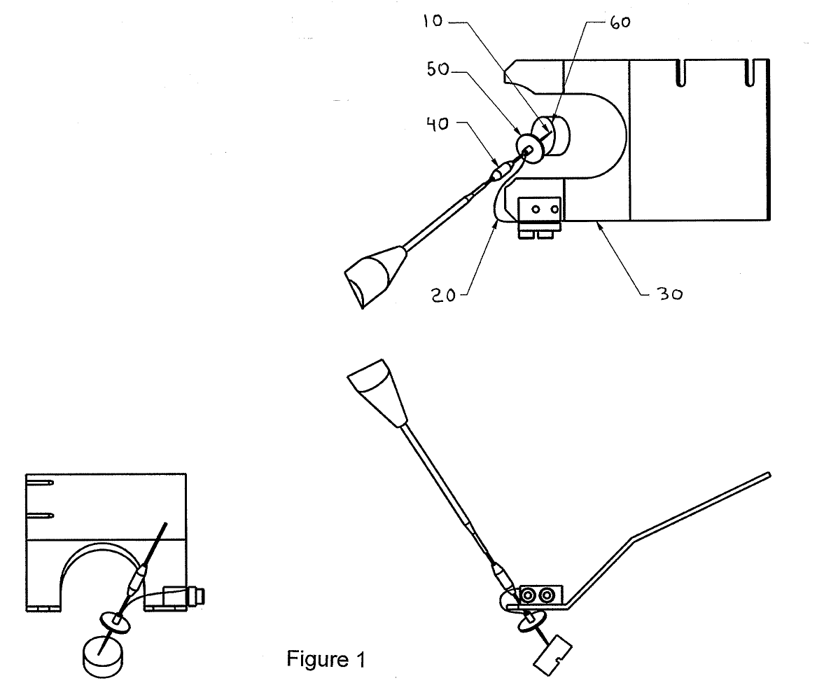

With respect to FIG. 1, there is shown a manipulator tip 10 made of material with high thermal conductivity. In an embodiment, the manipulator tip 10 is detachable to be replaceable. The manipulator tip is cooled with mechanical bonding to high thermal conductivity flexible braid 20. The other end of the braid is attached to a fixed structure 30 which is cooled to cryogenic temperatures, e.g. using liquid nitrogen. The braid is short to provide sufficient cooling to the tip. The braid is also flexible to allow the manipulator to be moved with in situ or ex situ control in the required precise fashion. Additional tips may be added to the same manipulator for the purpose of efficiently extracting more than one portion of the frozen sample in the process.

In an embodiment there is a thermal break 40 between the cooled tip and the remaining body of the manipulator. The thermal break serves two purposes. It makes the cooling of the tip more efficient by reducing thermal leakage. The thermal break also restricts malfunction and thermal drift of the manipulator. The thermal break needs to be sufficiently stiff in order for the braid connected tip to be moved with precision. The thermal break is achieved using a combination of low thermal conductivity material and low cross sectional area.

The prime reason for cooling the tip is to keep the specimen in the vitreous state. However, the cooling of the specimen depends strongly on the thermal conductivity of the bond between the tip 10 and the specimen 60 and the conductivity of the thin film specimen. Reducing other stray heat loads is anticipated to be useful as is common practice in other cryogenic apparatus. Any structure at ambient temperatures emits radiation which warms neighboring bodies even in a vacuum. This is termed black body radiation. Black body radiation reaching the cooled structure and specimen is reduced by using a cooled radiation shield 50 as shown in FIG. 1. The cooled shield is most effective when it presents the maximum solid angle to the specimen 60 appropriate to the lift out technique, is cooled to cryogenic temperatures, and when it has a highly polished metallic surface, for example copper or gold coated structure.

A further benefit of the cryogenically cooled shield or shields is to preferentially condense and hold any volatile material, normally existing as a low partial pressure of vapor within the vacuum chamber of the FIB system, which may otherwise condense onto the surface of the cooled sample causing contamination.

The objective is for the cooled shield(s) to present as large a solid angle to the excised sample as possible, as this will minimize the heat load. In an embodiment, the shield is attached to the cooled manipulator tip itself, above the point of contact with the sample, in which case the close proximity with the excised sample allows the shield dimensions to be small. In a further embodiment, a larger cooled shield is mounted separately from the cooled manipulator tip, with space to allow movement of the tip and functionality of other components of the FIB system but still presenting a large solid angle to the sample.

By providing a manipulator tip that can be cooled and maintained at a temperature below that of vitreous ice, which provides both an active cooling path and either combined or separate cryogenic shielding to maintain the temperature of the excised sample below that of vitreous ice, the attachment of the manipulator tip to a frozen sample and the transfer of the excised sample from the bulk sample by the manipulator tip can occur without a phase change in the frozen sample. The cryogenic shielding also helps to minimize contamination of the cooled sample by condensation of volatile material that may be present in the FIB. The invention relies on an established method of bonding and releasing the manipulator tip to and from the sample, using Ion Beam Induced Deposition, for example using a Pt precursor gas injected towards a target region in more than one step for bonding and use of the FIB to ‘compact’ the Pt deposit, for cleaning any superfluous Pt deposit and for releasing the manipulator tip from the sample following sample bonding to the cooled support structure. A similar established method of condensing water vapor for bonding and releasing the cooled manipulator tip to and from the sample may be employed.

Those skilled in the art will recognize other detailed designs and methods that can be developed employing the teachings of the present invention. The examples provided here are illustrative and do not limit the scope of the invention, which is defined by the attached claims.

1. A cooled manipulator tip assembly comprising:
a thermally isolated tip and
a thermal shield,
wherein said tip is adapted for bonding to a sample without changing phase of said sample and further adapted for removal of a portion of said sample without changing phase of said sample portion.

2. The cooled manipulator tip assembly of claim 1, wherein said thermal shield is cooled.

3. The cooled manipulator tip assembly of claim 1, further comprising a flexible conductor adapted for cooling said thermally isolated tip.

4. A system for extracting a sample portion from a cooled sample comprising
a cooled manipulator tip assembly comprising:
a thermally isolated tip and
a thermal shield,
and a cooled shield that is physically separate from said cooled manipulator tip assembly
wherein said thermally-isolated tip is adapted for bonding to a sample without changing phase of said sample and for removal of a portion of said sample without changing phase of said sample portion.

5. The system of claim 4, wherein said thermal shield is cooled.

6. The system of claim 4, further comprising a flexible conductor adapted for cooling said thermally isolated tip.

7. The system of claim 4, wherein said cooled manipulator tip assembly is contained within a vacuum environment of a Focused Ion Beam system.

8. The system of claim 4, further comprising a cryogenic cooling source for cooling said shield and tip.

9. A method for extracting a portion of a frozen sample, comprising:
attaching a thermally-isolated cooled tip of a manipulator to the sample,
removing a portion of the sample that is affixed to said tip without changing phase of the portion of the sample being removed,
transferring a portion of the sample that is affixed to said tip without changing phase of the portion to a separate cooled support structure,
bonding of a portion of the sample to the separate cooled support structure and
detaching said tip without changing phase of the portion of the sample

10. The method of claim 9, wherein said attaching and bonding is performed by vapor deposition.

11. The method of claim 9, wherein said removing a portion of the sample is performed by an ion beam.

12. The method of claim 9, wherein the sample is frozen and said thermally-isolated tip is maintained at a temperature below that of vitreous ice.

13. The method of claim 10, wherein said deposition comprises deposition of platinum.

14. The method of claim 9, wherein said the tip is contained within a vacuum environment in a Focused Ion Beam system.

15. The method of claim 9, further comprising cooling said tip at least in part with a cryogenic cooling source.

16. The method of claim 9, wherein said transferring is by means of in situ or ex situ movement of the manipulator tip.

17. The method of claim 9, wherein said detaching is performed by an ion beam.

18. The method of claim 10, wherein said deposition comprises deposition of water vapor.
